(19) United States
(12) Patent Application Publication
(10) Pub. No.: US 2009/0036407 A1
(43) Pub. Date: Feb. 5, 2009

(54) FLEA CONTROL METHOD

(76) Inventor: WENDY SUE TAYLOR, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/182,581

(22) Filed: Jul. 30, 2008

Related U.S. Application Data
(60) Provisional application No. 60/962,536, filed on Jul. 30, 2007.

(51) Int. Cl. A01N 57/00; A01N 43/40; A01P 7/04

(52) U.S. Cl. 514/75; 514/341

(57) ABSTRACT

This invention relates to a method of controlling or preventing maturation of fleas on an animal or its environment comprising applying to a warm blooded animal or its environment a composition comprising an developmentally disruptive amount of a compound of Formula 1 or an N-oxide, or a salt thereof.

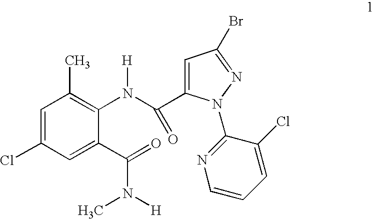

### FIELD OF THE INVENTION

The present invention relates to the use of compounds for control of fleas on homoiothermic or warm blooded animals and in another embodiment, the use of combinations of the compounds with other active ingredients to control both ectoparasites and endoparasites.

### BACKGROUND OF THE INVENTION

Infestation of animals by fleas has long been a nuisance. Because fleas are able to survive and multiply under a wide range of environmental conditions, controlling flea infestation requires a multifaceted program that must be vigorously applied to achieve any measure of success.

Infestation of animals, particularly dogs and cats, with fleas has several undesirable effects for the animals and their owners. Such undesirable effects include local irritation and annoying itching, leading to scratching. A high proportion of pet animals, particularly dogs, become allergic to flea saliva, resulting in the chronic condition known as flea bite allergy (or flea allergy). This condition causes the animal to bite and scratch, leading to excoriation of the skin, secondary pyogenic infection, hair loss, and chronic severe inflammatory skin changes. Furthermore, dogs and cats that are infested with fleas often also become infected with Dipylidium caninum, the tapeworm transmitted by fleas.

There is a pressing need therefore for improved control of fleas which infest warm blooded animals, particularly those kept as pets.

### SUMMARY OF THE INVENTION

This invention relates to a method of controlling or preventing maturation of fleas or other insects on a warm blooded animal or its environment comprising applying to the warm blooded animal or its environment a composition comprising a developmentally disruptive amount of a compound of Formula 1 (3-bromo-N-[4-chloro-2-methyl-6-[(methylamino)carbonyl]phenyl]-1-(3-chloro-2-pyridinyl)-1H-pyrazole-5-carboxamide) (otherwise known as Chlorantraniliprole (ISO)—Rynaxypyr™)

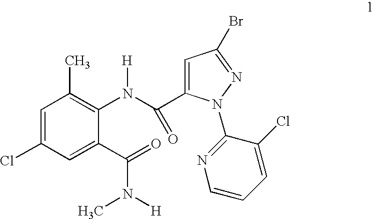

or an N-oxide, or a salt thereof. Pharmaceutically or veterinarily acceptable salts are contemplated.

The invention also comprises a compound of Formula 1 for use as a medicament.

The invention also relates to the use of a compound of Formula 1 in the manufacture of a medicament for the treatment of infestation of fleas on an animal

### DETAILS OF THE INVENTION

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

For the purposes of the present invention, the term flea is understood to refer to all the usual or accidental species of parasitic flea of the order Siphonaptera, and in particular the species Ctenocephalides, in particular C. felis and C. canis, rat fleas (Xenopsylla cheopis) and human fleas (Pulex irritans).

As used herein and generally, a “developmentally disruptive amount” is the amount of active ingredient needed to achieve an observable effect in arresting or preventing maturation of an invertebrate pest species to adulthood. One skilled in the art will appreciate that the developmentally disruptive dose or amount can vary for the various compounds and compositions of the present invention, the desired parasitical effect and duration, the target invertebrate pest species, the animal to be protected, the mode of application and the like, and the amount needed to achieve a particular result can be determined through simple experimentation.

Embodiments of the present invention include:
Embodiment 1 The method or use described in the Summary of the Invention wherein the insect is a flea.
Embodiment 2 The method of Embodiment 1 wherein the warm blooded animal is either a dog or a cat.
Embodiment 3 The method of either of Embodiment 1 or 2 wherein the compound of Formula 1 is contained within a composition which comprises at least one additional component selected from the group consisting of solvents and/or carriers, emulsifiers and/or dispersing agents.
Embodiment 4 The method of Embodiment 3 wherein the composition comprises at least one additional biologically active compound or agent.
Embodiment 5 The method of Embodiment 4 wherein the additional biologically active compound or agent is selected from the group consisting of macrocyclic lactones, acetyl cholinesterase inhibitors, arthropod growth regulators, GABA-gated chloride channel antagonists, mitochondrial electron transport inhibitors, nicotinic acetylcholine agonists/antagonists/activator, oxidative phosphorylation inhibitors, anthelminthics, sodium channel modulators or other antiparasitic compounds.
Embodiment 6 The method of Embodiment 5 wherein said biologically active compound is a macrocyclic lactone.
Embodiment 7 The method of Embodiment 5 wherein said biologically active compound is an acetyl cholinesterase inhibitor selected from the group of organophosphates and carbamates.
Embodiment 8 The method of Embodiment 5 wherein said biologically active compound is an arthropod growth regulator selected from the group of chitin synthesis inhibitors, ecdysone agonists/disruptors, lipid biosynthesis inhibitor and juvenile hormone mimics.
Embodiment 9 The method of Embodiment 5 wherein said biologically active compound is a GABA-gated chloride channel antagonist.
Embodiment 10 The method of Embodiment 5 wherein said biologically active compound is a mitochondrial electron transport inhibitor.
Embodiment 11 The method of Embodiment 5 wherein said biologically active compound is a nicotinic acetylcholine agonist/antagonist/activator.
Embodiment 12 The method of Embodiment 5 wherein said biologically active compound is an oxidative phosphorylation inhibitor.
Embodiment 13 The method of Embodiment 8 wherein said biologically active compound is an anthelminthic.
Embodiment 14 The method of Embodiment 8 wherein said biologically active compound is a sodium channel modulator.

The embodiments above are intended to be illustrative and not limiting. Further aspects of the invention are discussed throughout the specification.

This invention relates to a method of controlling or preventing maturation of fleas or other insects on an animal or its environment comprising applying to the animal or its environment a composition comprising a developmentally disruptive amount of a compound of Formula 1, or an N-oxide, or a pharmaceutically or veterinarily acceptable salts thereof,

Therefore, the invention is understood to include the compound of Formula 1. described in the Summary of the Invention (and compositions containing it) for use as an animal medicament, or more particularly a flea or other insect control medicament. The medicament may be presented in topical forms.

The invention is also understood to include the compound of Formula 1. described in the Summary of the Invention in the manufacture of medicaments for the protection of an animal from fleas or other insects. The medicament may be presented in topical forms.

The invention is also understood to include the compounds described in the Summary of the Invention for use in the manufacture of medicaments for the protection of an animal from fleas or other insects. The medicament may be presented in topical forms.

The invention is also understood to include the compounds described in the Summary of the Invention packaged and presented for the protection of an animal from fleas or other insects. The compounds of the invention may be packaged and presented as topical dosage forms.

The invention is also understood to include a process for manufacturing a composition for protecting an animal from an fleas and other insects characterized in that a compound of Formula 1 is admixed with at least one pharmaceutically or veterinarily acceptable carrier. The compositions of the invention may be packaged and presented in topical dosage forms.

Adult fleas live in the coat of the cat or dog and feed on blood. Male and female fleas mate still in the animal's coat and the female flea lays her eggs. The eggs do not generally adhere to the fur, but fall off and are distributed to the animal's environment. By this mechanism, while the total environment of the pet animal is infested with flea eggs, infestation is greatest in locations where the pet spends most of its time. Eggs hatch to larvae in about two days. There are three larval stages, each lasting about three days. In the last stage, the larva spins a cocoon and transforms into a pupa. Under optimum conditions (i.e., 33.degree. C. and 65% relative humidity), eggs develop through larvae to pupae in about 8-10 days. After a further period of approximately 8 days, the pupae develop into young adult fleas in the cocoon, still dispersed in the pet's environment. These pre-emerged adult fleas wait in their pupae until they sense, by carbon dioxide tension and/or vibrations, the presence of an animal host, and then emerge explosively and jump into the air and onto the passing host. Under suitable environmental conditions of temperature and humidity, unfed emerged fleas that fail to find a host can survive for some time in the environment, waiting for a suitable host. It takes at least three weeks for eggs to develop to pre-emerged adults, able to reinfest a host animal. However, the pre-emerged adults can remain viable in the cocoon for months, as long as one year. In addition, under sub-optimal temperature conditions, it can take 4-5 months for eggs to develop into pupae containing pre-emerged adults. Larvae feed on almost any organic debris in the floor covering, but their main dietary component is dried adult flea fecal matter. Adult flea feces, also known as “flea dirt”, consist of relatively undigested blood which dries and falls from the pet to serve as food for the newly hatched larvae. Fleas require a blood meal in order to become sexually mature and able to reproduce. After their first blood meal, they undergo a shift in metabolism such that they cannot survive for any time off the host. The blood must come from the correct animal and the female flea's appetite requires that it consumes as much as 5 times its body weight of blood each day. The long life cycle, and especially, the extended period of pre-emergence dormancy, has made flea control with compounds applied topically to pet animals difficult and not entirely satisfactory. Most topically applied active ingredients have a limited residual effect, thus reinfestation by newly-emerged adults from the pet's environment is a constant problem.

The compounds of Formula 1 which can be used according to the invention, have an excellent action against the maturation of flea ova, whilst being very well tolerated by animals. The invention thus represents a genuine enrichment of the art.

The compounds according to the invention possess a good developmental activity, whilst being of low toxicity to animals.

The compound of Formula 1 can be prepared by one or more of the methods and variations thereof as described in World Patent Application Publication WO 03/015519 and U.S. Pat. No. 7,232,836 (which is hereby incorporated by reference to the extent not inconsistent with the disclosure herein). Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

### Application of Compounds of the Invention

The compound of Formula 1 of this invention can be applied to animals that can be bothered by fleas and their environment. Humans and their environment may also be treated. With respect to treatment of the animals active compounds are employed in a known manner, preferably by dermal or topical use. In the method of the present invention, fleas are exposed to an developmentally disruptive amount of the active ingredient when they first climb on to an animal which has been treated. Larvae which feed on dried adult flea fecal matter from these treated fleas, also known as “flea dirt”, can be affected by the compound which prevents development of the eggs and breaks the flea life cycle.

The “applying” to the animal or the environment can be accomplished by way of non limiting example, by sprays, dusts, pour on treatments and controlled-release devices, such as ear tags and tapes, neck collars, ear tags, tail bands, limb bands or halters which comprise compounds or compositions comprising compounds of Formula 1. In addition to sprays and pour on treatments, application may be by other forms of topical administration, for example, in the form of immersion or dipping, washing, coating with powder, or application to a small area of the animal.

Application of the compositions according to the invention to the animals to be treated is done topically via solutions, emulsions, suspensions, (drenches), powders, and pour-on formulations.

The pour-on or spot-on method consists in applying the compound of Formula 1 to a specific location of the skin or coat, advantageously to the neck or backbone of the animal. This takes place e.g. by applying a swab or spray of the pour-on or spot-on formulation to a relatively small area of the coat, from where the active substance is dispersed almost automatically over wide areas of the fur owing to the spreading nature of the components in the formulation and assisted by the animal's movements.

Importantly the compounds of Formula 1 may be indirectly applied to an animal by applying it to the local environment in which the animal dwells (such as bedding, enclosures, or the like). Effective use rates will range from about 1.0 to 50 mg/square meter but as little as 0.1 mg/square meter may be sufficient or as much as 150 mg/square meter may be required. One skilled in the art can easily determine the biologically effective amount necessary for the desired level of pest control.

The invention notably provides a process for controlling the fleas of small mammals, and in particular cats and dogs, is treated by locally depositing on the skin, preferably localized over a small surface area (spot-on application) It is preferable for the treatment according to the invention to be carried out every one, two or, preferably, every three months on cats and dogs.

The compounds of the present invention may be administered in a controlled release form, e.g., in a subcutaneous slow release formulation, or in the form of a controlled release device affixed to an animal such as a fleacollar. Collars for the controlled release of an insecticide agent for long term protection against flea infestation in a companion animal are art-known, and are described, for example, by U.S. Pat. No. 3,852,416, U.S. Pat. No. 4,224,901, U.S. Pat. No. 5,555,848 and U.S. Pat. No. 5,184,573.

Compositions of the Invention

The compounds are prepared or formulated into compositions in a known manner, for example by extending the active compounds with solvents and/or carriers, if appropriate using emulsifiers and/or dispersing agents; if, for example, water is used as the diluent, organic solvents can, if appropriate, be used as auxiliary solvents.

A composition used in the present invention which is intended to be applied to an animal comprises a mixture of a compound of Formula 1, an N-oxide or a salt thereof, with one or more pharmaceutically or veterinarily acceptable carriers comprising excipients and auxiliaries selected with regard to their suitability for topical administration and in accordance with standard practice. In addition, a suitable carrier is selected on the basis of compatibility with the one or more active ingredients in the composition, including such considerations as stability relative to pH and moisture content. The typical application medium will be a composition for protecting an animal from an invertebrate parasitic pest comprising a parasitically effective amount of a compound of Formula 1 and at least one carrier.

Formulations for topical administration are typically in the form of a powder, cream, suspension, spray, emulsion, foam, paste, aerosol, ointment, salve or gel. More typically a topical formulation is a water-soluble solution, which can be in the form of a concentrate that is diluted before use. Parasiticidal compositions suitable for topical administration typically comprise a compound of the present invention and one or more topically suitable carriers.

In applications of a parasiticidal composition topically to the exterior of an animal as a line or spot (i.e. “spot-on” treatment), the active ingredient migrates over the surface of the animal to cover most or all of its external surface area. As a result, the treated animal is particularly protected from invertebrate pests that feed off the epidermis of the animal such as ticks, fleas and lice. Therefore formulations for topical localized administration often comprise at least one organic solvent to facilitate transport of the active ingredient over the skin and/or penetration into the epidermis of the animal. Pour-on or spot-on formulations suitably contain carriers, which promote rapid dispersement over the skin surface or in the coat of the host animal, and are generally regarded as spreading oils. Suitable carriers are e.g. oily solutions; alcoholic and isopropanolic solutions such as solutions of 2-octyldodecanol or oleyl alcohol; solutions in esters of monocarboxylic acids, such as isopropyl myristate, isopropyl palmitate, lauric acid oxalate, oleic acid oleyl ester, oleic acid decyl ester, hexyl laurate, oleyl oleate, decyl oleate, capric acid esters of saturated fat alcohols of chain length C₁₂-C₁₈; solutions of esters of dicarboxylic acids, such as dibutyl phthalate, diisopropyl isophthalate, adipic acid diisopropyl ester, di-n-butyl adipate or also solutions of esters of aliphatic acids, e.g. glycols. It may be advantageous for a dispersing agent to be additionally present, such as one known from the pharmaceutical or cosmetic industry. Examples are 2-pyrrolidone, 2-(N-alkyl)pyrrolidone, acetone, polyethylene glycol and the ethers and esters thereof, propylene glycol or synthetic triglycerides.

The oily solutions include e.g. vegetable oils such as olive oil, groundnut oil, sesame oil, pine oil, linseed oil or castor oil. The vegetable oils may also be present in epoxidised form. Paraffins and silicone oils may also be used.

It may be advantageous for a crystallization inhibitor or a dispersant known from the pharmaceutical or cosmetic industry also to be present.

A pour-on or spot-on formulation generally contains 1 to 20% by weight of a compound of Formula 1, 0.1 to 50% by weight of dispersing agent and 45 to 98.9% by weight of solvent.

The compositions for spot-on application can advantageously comprise:
(a) a crystallization inhibitor, in particular one which is present in a proportion of from 1 to 20% (w/v), preferably from 5 to 15%, this inhibitor satisfying the test according to which: 0.3 ml of 10% (w/v) of a compound of Formula 1 in the solvent defined in (c) below, along with 10% of this inhibitor, are deposited on a glass slide at 20° C. for 24 hours, after which it is observed with the naked eye that there are few or no crystals, in particular fewer than 10 crystals, preferably 0 crystals on the glass slide, (b) an organic solvent having a dielectric constant of between 10 and 35, preferably of between 20 and 30, the content of this solvent
(b) in the overall composition preferably representing the difference to make the composition up to 100%,
(c) an organic cosolvent having a boiling point of below 100°. C., preferably of below 80° C., and having a dielectric constant of between 10 and 40, preferably of between 20 and 30; this cosolvent may advantageously be present in the composition in a (c)/b) weight/weight (w/w) ratio of between 1/15 and 1/2. The solvent is volatile, so as to serve in particular as a drying promoter, and is miscible with water and/or with the solvent (b).

The pour-on formulations include a carrier and can also include one or more additional ingredients. Examples of suitable additional ingredients are stabilizers such as antioxidants, spreading agents, preservatives, adhesion promoters, active solubilisers such as oleic acid, viscosity modifiers, UV blockers or absorbers, and colourants. Surface active agents, including anionic, cationic, non-ionic and ampholytic surface active agents, can also be included in these formulations.

The formulations of this invention often include an antioxidant, such as BHT (butylated hydroxytoluene). The antioxidant is generally present in amounts of at 0.005-5% (w/v) a proportion of from 0.005 to 1% (w/v) is often used, with 0.01 to 0.05% often preferred.

The compositions according to the invention intended for pets, in particular cats and dogs, are generally applied by being deposited onto the skin (“spot-on” or “pour-on” application); this is generally a localized application over a surface area of less than 10 cm², especially of between 5 and 10 cm2, in particular at two points and preferably localized between the animal's shoulders. Once deposited, the composition diffuses, in particular over the animal's entire body, and then dries without crystallizing or modifying the appearance (in particular absence of any whitish deposit or dusty appearance) or the feel of the fur. The compositions for spot-on application according to the invention are particularly advantageous owing to their efficacy, their speed of action and the pleasant appearance of the animal's fur after application and drying.

As organic solvent (b) which can be used in the invention, mention may be made in particular of: acetone, acetonitrile, benzyl alcohol, butyl diglycol, dimethylacetamide, dimethylformamide, dipropylene glycol n-butyl ether, ethanol, isopropanol, methanol, ethylene glycol monoethyl ether, ethylene glycol monomethyl ether, monomethylacetamide, dipropylene glycol monomethyl ether, liquid polyoxyethylene glycols, propylene glycol, 2-pyrrolidone, in particular N-methylpyrrolidone, diethylene glycol monoethyl ether, ethylene glycol and diethyl phthalate, or a mixture of at least two of these solvents.

As crystallization inhibitor (a) which can be used in the invention, mention may be made in particular of: polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters; lecithin, sodium carboxymethylcellulose, acrylic derivatives such as methacrylates and the like, anionic surfactants such as alkaline stearates, in particular sodium, potassium or ammonium stearate; calcium stearate; triethanolamine stearate; sodium abietate; alkyl sulphates, in particular sodium lauryl sulphate and sodium cetyl sulphate; sodium dodecylbenzenesulphonate, sodium dioctylsulphosuccinate; fatty acids, in particular those derived from coconut oil, cationic surfactants such as water-soluble quaternary ammonium salts of formula N^{|} R′R″R′″R″″,Y— in which the radicals R are optionally hydroxylated hydrocarbon radicals and Y⁻ is an anion of a strong acid such as the halide, sulphate and sulphonate anions; cetyltrimethylammonium bromide is among the cationic surfactants which can be used, amine salts of formula N^{|}R′R″R′″ in which the radicals R are optionally hydroxylated hydrocarbon radicals; octadecylamine hydrochloride is among the cationic surfactants which can be used, nonionic surfactants such as optionally polyoxyethylenated sorbitan esters, in particular polysorbate 80, polyoxyethylenated alkyl ethers; polyethylene glycol stearate, polyoxyethylenated derivatives of castor oil, polyglycerol esters, polyoxyethylenated fatty alcohols, polyoxyethylenated fatty acids, copolymers of ethylene oxide and propylene oxide, amphoteric surfactants such as substituted lauryl compounds of betaine, or preferably a mixture of at least two of these crystallization inhibitors.

In a particularly preferred manner, a crystallization inhibitor couple, namely the combination of a film-forming agent of polymeric type and a surfactant, will be used. These agents will be chosen in particular from the compounds mentioned as crystallization inhibitor b).

Among the film-forming agents of polymeric type which are particularly advantageous, mention may be made of: the various grades of polyvinylpyrrolidone, polyvinyl alcohols, and copolymers of vinyl acetate and vinylpyrrolidone.

As regards the surfactants, mention will be made most particularly of nonionic surfactants, preferably polyoxyethylenated sorbitan esters and in particular the various grades of polysorbate, for example polysorbate 80.

The film-forming agent and the surfactant may be incorporated, in particular, in similar or identical amounts within the limit of the total amounts of crystallization inhibitor mentioned elsewhere.

The couple thus produced ensures the objectives of absence of crystallization on the hairs and maintenance of the cosmetic appearance of the coat in a note-worthy manner, that is to say without any tendency towards stickiness or to a sticky appearance, despite the high concentration of active material.

As cosolvent (c), mention may be made in particular of: absolute ethanol, isopropanol, methanol.

As antioxidant, standard agents are used in particular, such as: butylhydroxyanisole, butylhydroxytoluene, ascorbic acid, sodium metabisulphite, propyl gallate and sodium thiosulphate, or a mixture of not more than two of these agents.

The compositions for spot-on application according to the invention are usually prepared by simple mixing of the constituents as defined earlier; advantageously, to begin with, the active material is mixed in the main solvent and the other ingredients or adjuvants are then added.

The volume applied may be from about 0.3 to 1 ml, preferably about 0.5 ml for cats, and from about 0.3 to 5 ml for dogs, according to the weight of the animal.

The composition according to the invention may be in the form of a concentrated emulsion, suspension or solution for spot-on application to a small area of the animal's skin, generally between the two shoulders (spot-on type solution). In a another aspect of the invention forms of solution or suspension to be sprayed, forms of solution, suspension or emulsion to be poured or spread onto the animal (pour-on type solution) an oil, a cream, an ointment or any other fluid formulation for topical administration may be provided.

Other delivery systems for relatively hydrophobic pharmaceutical compounds may be employed. Liposomes and emulsions are well-known examples of delivery vehicles or carriers for hydrophobic drugs. In addition, organic solvents such as dimethylsulfoxide may be used.

The compounds of Formula 1 are generally present in the compositions in concentrations of 0.1 to 95 percent by weight, preferably 0.5 to 90 percent by weight. Preparations which are intended for direct application contain the active compound according to the invention in concentrations of between 0.001 and 5 percent by weight, preferably 0.005 to 3 percent by weight.

Dosages may range from 0.0001 mg/kg of animal body weight to about 1000 mg/kg. of the compound of Formula 1. Sometimes dosages may be from 0.1 mg/kg of animal body weight to about 200 mg/kg. Often times it would be advantageous to administer amounts of about 0.01 to about 100 mg or between 0.02 to about 50mg/kg. and frequently between 0.1 and 75 mg/kg. Preferably, the treatment is carried out so as to administer to the animal a dose of from 0.1 to 40 mg/kg and in particular from 1 to 30 mg/kg. Administration may be given as a single dose or intermittent in time and may be administered daily, weekly, monthly, bimonthly or quarterly in order to achieve effective results in order to achieve effective results.

Nevertheless it can at times be necessary to deviate from the amounts mentioned, and in particular to do so in accordance with the body weight of the test animal and/or the method of application, but also because of the species of animal and its individual behavior towards the medicament, or the nature of the formulation of the latter and the time or interval at which it is administered. Thus it can suffice in some cases to manage with less than the above mentioned minimum amount while in other cases the upper limit mentioned must be exceeded. Where substantial amounts are applied, it can be advisable to divide these into several individual administrations over the course of the day. The general sense of the other statements made above also applies.

### The Methods of the Invention May Comprise the Administration of Additional Active Compounds:

It is contemplated that additional biologically active compounds may be be administered at the same time or separately over time to obtain broader spectrum of pest control or to attack adult fleas. Such additional biologically active compounds may be packaged together with the compound of Formula 1 as a kit. For convenience sake such additional biologically active compounds may be formulated into the same composition containing the compound of Formula 1. Therefore the present invention contemplates the use of compositions characterised in that they contain, in addition to a compound of Formula 1, further auxiliaries and/or active compounds, such as additional biologically active compounds, disinfectants or antibiotics may be admixed to the formulations, or the ready-to-use solutions, in addition to the customary solid or liquid extenders, diluents and/or surface-active agents.

Of note are additional biologically active compounds or agents selected from art-known anthelmintics, such as, for example, avermectins (e.g. ivermectin, moxidectin, milbemycin), benzimidazoles (e.g. albendazole, triclabendazole), salicylanilides (e.g. closantel, oxyclozanide), substituted phenols (e.g. nitroxynil), pyrimidines (e.g. pyrantel), imidazothiazoles (e.g. levamisole) and praziquantel.

Other biologically active compounds or agents useful in the compositions of the present invention can be selected from Insect Growth Regulators (IGRs) and Juvenile Hormone Analogues (JHAs) such as diflubenzuron, triflumuron, fluazuron, cyromazine, methoprene, etc., thereby providing both initial and sustained control of parasites (at all stages of insect development, including eggs) on the animal subject, as well as within the environment of the animal subject.

The compounds of Formula 1 according to the invention may be used alone or in combination with other biocides. They may be combined with pesticides having the same sphere of activity e.g. to increase activity, or with substances having another sphere of activity e.g. to broaden the range of activity. It can also be sensible to add so-called repellents. If the range of activity is to be extended to endoparasites, e.g. wormers, the compounds of Formula 1 are suitably combined with substances having endoparasitic properties. Of course, they can also be used in combination with antibacterial compositions.

Preferred groups of combination partners and especially preferred combination partners are named in the following, whereby combinations may contain one or more of these partners in addition to a compound of Formula 1.

Suitable partners in the mixture may be biocides, e.g. the insecticides and acaricides with a varying mechanism of activity, which are named in the following and have been known to the person skilled in the art for a long time, e.g. chitin synthesis inhibitors, growth regulators; active ingredients which act as juvenile hormones; active ingredients which act as adulticides; broad-band insecticides, broad-band acaricides and nematicides; and also the well known anthelminthics and insect- and/or acarid-deterring substances, and also repellents or detachers.

Examples of such biologically active compounds include but are not restricted to the following: Organophosphates, a class which are generally know to be inhibitors of acetyl cholinesterase: acephate, azamethiphos, azinphos-ethyl, azinphos-methyi, bromophos, bromophos-ethyl, cadusafos, chlorethoxyphos, chlorpyrifos, chlorfenvinphos, chlormephos, demeton, demeton-S-methyl, demeton-S-methyl sulphone, dialifos, diazinon, dichlorvos, dicrotophos, dimethoate, disulfoton, ethion, ethoprophos, etrimfos, famphur, fenamiphos, fenitrothion, fensulfothion, fenthion, flupyrazofos, fonofos, formothion, fosthiazate, heptenophos, isazophos, isothioate, isoxathion, malathion, methacriphos, methamidophos, methidathion, methyl-parathion, mevinphos, monocrotophos, naled, omethoate, oxydemeton-methyl, paraoxon, parathion, parathion-methyl, phenthoate, phosalone, phosfolan, phosphocarb, phosmet, phosphamidon, phorate, phoxim, pirimiphos, pirimiphos-methyl, profenofos, propaphos, proetamphos, prothiofos, pyraclofos, pyridapenthion, quinalphos, sulprophos, temephos, terbufos, tebupirimfos, tetrachlorvinphos, thimeton, triazophos, trichlorfon, vamidothion.

Carbamates, a class which are generally known to be inhibitors of acetyl cholinesterase: alanycarb, aldicarb, 2-sec-butylphenyl methylcarbamate, benfuracarb, carbaryl, carbofuran, carbosulfan, cloethocarb, ethiofencarb, fenoxycarb, fenthiocarb, furathiocarb, HCN-801, isoprocarb, indoxacarb, methiocarb, methomyl, 5 methyl-m-cumenylbutyryl(methyl)carbamate, oxamyi, pirimicarb, propoxur, thiodicarb, thiofanox, triazamate, UC-51717 Pyrethroids, a class which are generally known to be modulators of sodium channels: acrinathin, allethrin, alphametrin, 5-benzyl-3-furylmethyl (E)-(1 R)-cis-2,2-dimethyl-3-(2-oxothiolan-3-ylidenemethyl)cyclopropanecarboxylate, bifenthrin, 8 cyfluthrin, cyfluthrin, oc-cypermethrin, 8-cypermethrin, bioallethrin, bioallethrin((S)-I cyclopentylisomer), bioresmethrin, bifenthrin, NCI-85193, cycloprothrin, cyhalothrin, cythithrin, cyphenothrin, deltamethrin, empenthrin, esfenvalerate, ethofenprox, fenfluthrin, fenpropathrin, fenvalerate, flucythrinate, flumethrin, fluvalinate (D isomer), imiprothrin, cyhalothrin, \-cyhalothrin, permethrin, phenothrin, prallethrin, pyrethrins (natural products), resmethrin, tetramethrin, transfluthrin, theta-cypermethrin, silafluofen, T-fluvalinate, tefluthrin, tralomethrin, Zeta-cypermethrin.

Arthropod growth regulators including: a) chitin synthesis inhibitors: benzoylureas: chlorfluazuron, diflubenzuron, fluazuron, flucycloxuron, flufenoxuron, hexaflumuron, lufenuron, novaluron, teflubenzuron, triflumuron, buprofezin, diofenolan, hexythiazox, etoxazole, chlorfentazine; b) ecdysone agonists/disruptors: halofenozide, methoxyfenozide, tebufenozide; c) juvenoid hormone mimcs: pyriproxyfen, methoprene, fenoxycarb; d) lipid biosynthesis inhibitors: spirodiclofen. Other antiparasitics: acequinocyl, amitraz, AKD-1022, ANS-118, azadirachtin, Bacillus thuringiensis, bensultap, bifenazate, binapacryl, bromopropylate, BTG-504, I BTG-505, camphechlor, cartap, chlorobenzilate, chlordimeform, chlorfenapyr, chromafenozide, clothianidine, cyromazine, diacloden, diafenthiuron, DBI-3204, dinactin, dihydroxymethyidihydroxypyrrolidine, dinobuton, dinocap, endosulfan, ethiprole, ethofenprox, fenazaquin, flumite, MTI-800, fenpyroximate, fluacrypyrim, flubenzimine, flubrocythrinate, flufenzine, flufenprox, fluproxyfen, halofenprox, hydramethyinon, IKI-220, kanemite, NC-196, neem guard, nidinorterfuran, nitenpyram, SD-35651, WL-108477, pirydaryl, propargite, protrifenbute, pymethrozine, pyridaben, pyrimidifen, NC-1111, R-195, RH-0345, RH-2485, RYI-210, S-1283, S-1833, S1-8601, silafluofen, silomadine, spinosad, tebufenpyrad, tetradifon, tetranactin, thiacloprid, thiocyclam, thiamethoxam, tolfenpyrad, triazamate, triethoxyspinosyn, trinactin, verbutin, vertalec, Y1-5301 Fungicides: acibenzolar, aldimorph, ampropylfos, andoprim, azaconazole, azoxystrobin, benalaxyl, benomyl, bialaphos, blasticidin-S, Bordeaux mixture, bromuconazole, bupirimate, carpropamid, captafol, captan, carbendazim, chlorfenazole, chloroneb, chloropicrin, chlorothalonil, chlozolinate, copper oxychloride, copper salts, cyflufenamid, cymoxanil, cyproconazole, cyprodinil, cyprofuram, RH-7281, diclocymet, diclobutrazole, diclomezine, dicloran, difenoconazole, RP-407213, dimethomorph, domoxystrobin, diniconazole, diniconazole-M, dodine, edifenphos, epoxiconazole, famoxadone, fenamidone, fenarimol, fenbuconazole, fencaramid, fenpiclonil, fenpropidin, fenpropimorph, fentin acetate, fluazinam, fludioxonil, flumetover, flumorf/flumorlin, fentin hydroxide, fluoxastrobin, fluquinconazole, flusilazole, flutolanil, flutriafol, folpet, fosetyl-aluminium, furalaxyl, furametapyr, hexaconazole, ipconazole, iprobenfos, iprodione, isoprothiolane, kasugamycin, krsoxim-methyl, mancozeb, maneb, mefenoxam, mepronil, metalaxyl, metconazole, metominostrobin/fenominostrobin, metrafenone, myclobutanil, neo-asozin, nicobifen, orysastrobin, oxadixyl, penconazole, pencycuron, probenazole, prochloraz, propamocarb, propioconazole, proquinazid, prothioconazole, pyrifenox, pyraclostrobin, pyrimethanil, pyroquilon, quinoxyfen, spiroxamine, sulfur, tebuconazole, tetrconazole, thiabendazole, thifluzamide, thiophanate-methyl, thiram, tiadinil, triadimefon, triadimenol, tricyclazole, trifioxystrobin, triticonazole, validamycin, vinclozin Biological agents: Bacillus thuringiensis ssp alzawai, kurstaki, Bacillus thuringiensis delta endotoxin, baculovirus, entomopathogenic bacteria, virus and fungi Bactericides: chlortetracycline, oxytetracycline, streptomycin,

Additional more specific examples of partner insecticides and acaricides are listed below:

| Compound | Class |
|---|---|
| Compound | Class |
| Abamectin | macrocyclic lactones |
| AC 303 630 | energy production modulator |
| Acephate | acetyl cholinesterase inhibitor |
| Acrinathrin | sodium channel modulator |
| Alanycarb | acetyl cholinesterase inhibitor |
| Aldicarb | acetyl cholinesterase inhibitor |
| alpha.-Cypermethrin | sodium channel modulator |
| Alphamethrin | sodium channel modulator |
| Amitraz | octopamine receptor ligand |
| Avermectin | macrocyclic lactones |
| Azinphos A | acetyl cholinesterase inhibitor |
| Azinphos M | acetyl cholinesterase inhibitor |
| Azinphos-methyl | acetyl cholinesterase inhibitor |
| Azocyclotin | oxidative phosphorylation inhibitor |
| Bacillus subtil. toxin | |
| Bendiocarb | acetyl cholinesterase inhibitor |
| Benfuracarb | acetyl cholinesterase inhibitor |
| Bensultap | nicotinic acetylcholine agonist/antagonist |
| beta.-Cyfluthrin | sodium channel modulator |
| Bifenthrin | sodium channel modulator |
| Brofenprox | sodium channel modulator |
| Bromophos A | acetyl cholinesterase inhibitor |
| Bufencarb | acetyl cholinesterase inhibitor |
| Buprofezin | chitin synthesis inhibitor |
| Butocarboxin | acetyl cholinesterase inhibitor |
| Cadusafos | acetyl cholinesterase inhibitor |
| Carbaryl | acetyl cholinesterase inhibitor |
| Carbofuran | acetyl cholinesterase inhibitor |
| Carbophenthion | acetyl cholinesterase inhibitor |
| Cartap | nicotinic acetylcholine agonist/antagonist |
| Chloethocarb | acetyl cholinesterase inhibitor |
| Chlorethoxyfos | acetyl cholinesterase inhibitor |
| Chlorfenapyr | oxidative phosphorylation inhibitor |
| Chlorfluazuron | chitin synthesis inhibitor |
| Chlormephos | acetyl cholinesterase inhibitor |
| Chlorpyrifos | acetyl cholinesterase inhibitor |
| Cis-Resmethrin | sodium channel modulator |
| Clofentezine | |
| Cyanophos | acetyl cholinesterase inhibitor |
| Cycloprothrin | sodium channel modulator |
| Cyfluthrin | sodium channel modulator |
| Cyhexatin | oxidative phosphorylation inhibitor |
| D 2341 (bifenazate) | |
| Deltamethrin | sodium channel modulator |
| Demeton M | acetyl cholinesterase inhibitor |
| Demeton S | acetyl cholinesterase inhibitor |
| Demeton-S-methyl | acetyl cholinesterase inhibitor |
| Dichlofenthion | acetyl cholinesterase inhibitor |
| Dicliphos | acetyl cholinesterase inhibitor |
| Diethion | acetyl cholinesterase inhibitor |
| Diflubenzuron | chitin synthesis inhibitor |
| Dimethoate | acetyl cholinesterase inhibitor |
| Dimethylvinphos | acetyl cholinesterase inhibitor |
| Dioxathion | acetyl cholinesterase inhibitor |
| Doramectin | macrocyclic lactones |
| DPX-MP062 (indoxacarb) | sodium channel modulator |
| Edifenphos | acetyl cholinesterase inhibitor |
| Emamectin | macrocyclic lactones |
| Endosulfan | gaba-gated chloride channel antagonist |
| Eprinomectin | macrocyclic lactones |
| Esfenvalerate | sodium channel modulator |
| Ethiofencarb | acetyl cholinesterase inhibitor |
| Ethion | acetyl cholinesterase inhibitor |
| Ethofenprox | sodium channel modulator |
| Ethoprophos | acetyl cholinesterase inhibitor |
| Etrimphos | acetyl cholinesterase inhibitor |
| Fenamiphos | acetyl cholinesterase inhibitor |
| Fenazaquin | mitochondrial electron transport inhibitor |
| Fenbutatin oxide | oxidative phosphorylation inhibitor |
| Fenitrothion | acetyl cholinesterase inhibitor |
| Fenobucarb (BPMC) | acetyl cholinesterase inhibitor |
| Fenothiocarb | acetyl cholinesterase inhibitor |
| Fenoxycarb | juvenile hormone mimic |
| Fenpropathrin | sodium channel modulator |
| Fenpyrad | mitochondrial electron transport inhibitor |
| Fenpyroximate | mitochondrial electron transport inhibitor |
| Fenthion | acetyl cholinesterase inhibitor |
| Fenvalerate | sodium channel modulator |
| Fipronil | gaba-gated chloride channel antagonist |
| Fluazinam | oxidative phosphorylation uncoupler |
| Fluazuron | chitin synthesis inhibitor |
| Flucycloxuron | chitin synthesis inhibitor |
| Flucythrinate | sodium channel modulator |
| Flufenoxuron | chitin synthesis inhibitor |
| Flufenprox | sodium channel modulator |
| Fonophos | acetyl cholinesterase inhibitor |
| Formothion | acetyl cholinesterase inhibitor |
| Fosthiazate | acetyl cholinesterase inhibitor |
| HCH | gaba-gated chloride channel antagonist |
| Heptenophos | acetyl cholinesterase inhibitor |
| Hexaflumuron | chitin synthesis inhibitor |
| Hexythiazox | |
| Hydroprene | juvenile hormone mimic |
| Imidacloprid | nicotinic acetylcholine agonist/antagonist |
| insect-active fungi | |
| insect-active nematodes | |
| insect-active viruses | |
| Iprobenfos | acetyl cholinesterase inhibitor |
| Isofenphos | acetyl cholinesterase inhibitor |
| Isoprocarb | acetyl cholinesterase inhibitor |
| Isoxathion | acetyl cholinesterase inhibitor |
| Ivermectin | chloride channel activator |
| lambda.-Cyhalothrin | sodium channel modulator |
| Lufenuron | chitin synthesis inhibitor |
| Malathion | acetyl cholinesterase inhibitor |
| Mecarbam | acetyl cholinesterase inhibitor |
| Mesulfenphos | acetyl cholinesterase inhibitor |
| Metaldehyd | |
| Methamidophos | acetyl cholinesterase inhibitor |
| Methiocarb | acetyl cholinesterase inhibitor |
| Methomyl | acetyl cholinesterase inhibitor |
| Methoprene | juvenile hormone mimic |
| Metolcarb | acetyl cholinesterase inhibitor |
| Mevinphos | acetyl cholinesterase inhibitor |
| Milbemectin | macrocyclic lactones |
| Moxidectin | macrocyclic lactones |
| Naled | acetyl cholinesterase inhibitor |
| NI-25, Acetamiprid | nicotinic acetylcholine agonist/antagonist |
| Nitenpyram | nicotinic acetylcholine agonist/antagonist |
| Nodulisporic acid/derivatives | macrocyclic lactones |
| Omethoat | acetyl cholinesterase inhibitor |
| Oxamyl | acetyl cholinesterase inhibitor |
| Oxydemethon M | acetyl cholinesterase inhibitor |
| Oxydeprofos | acetyl cholinesterase inhibitor |
| Parathion | acetyl cholinesterase inhibitor |
| Parathion-methyl | acetyl cholinesterase inhibitor |
| Permethrin | sodium channel modulator |
| Phenthoate | acetyl cholinesterase inhibitor |
| Phorat | acetyl cholinesterase inhibitor |
| Phosalone | acetyl cholinesterase inhibitor |
| Phosmet | acetyl cholinesterase inhibitor |
| Phoxim | acetyl cholinesterase inhibitor |
| Pirimicarb | acetyl cholinesterase inhibitor |
| Pirimiphos A | acetyl cholinesterase inhibitor |
| Pirimiphos M | acetyl cholinesterase inhibitor |
| Promecarb | acetyl cholinesterase inhibitor |
| Propaphos | acetyl cholinesterase inhibitor |
| Propoxur | acetyl cholinesterase inhibitor |
| Prothiofos | acetyl cholinesterase inhibitor |
| Prothoat | acetyl cholinesterase inhibitor |
| Pyrachlophos | acetyl cholinesterase inhibitor |
| Pyradaphenthion | acetyl cholinesterase inhibitor |
| Pyresmethrin | sodium channel modulator |
| Pyrethrim | sodium channel modulator |
| Pyridaben | mitochondrial electron transport inhibitor |
| Pyrimidifen | mitochondrial electron transport inhibitor |
| Pyriproxyfen | juvenile hormone mimic |
| RH 5992 | ecdysone agonist |
| RH-2485 | ecdysone agonist |
| Salithion | acetyl cholinesterase inhibitor |
| selamectin | macrocyclic lactones |
| Silafluofen | sodium channel modulator |
| Spinosad | nicotinic acetylcholine activator |
| Sulfotep | acetyl cholinesterase inhibitor |
| Sulprofos | acetyl cholinesterase inhibitor |
| Tebufenozide | ecdysone agonist |
| Tebufenpyrad | mitochondrial electron transport inhibitor |
| Tebupirimphos | acetyl cholinesterase inhibitor |
| Teflubenzuron | chitin synthesis inhibitor |
| Tefluthrin | sodium channel modulator |
| Temephos | acetyl cholinesterase inhibitor |
| Terbufos | acetyl cholinesterase inhibitor |
| Tetrachlorvinphos | acetyl cholinesterase inhibitor |
| Thiafenox | |
| Thiodicarb | acetyl cholinesterase inhibitor |
| Thiofanox | acetyl cholinesterase inhibitor |
| Thionazin | acetyl cholinesterase inhibitor |
| Thuringiensin | |
| Tralomethrin | sodium channel modulator |
| Triarathen | |
| Triazamate | acetyl cholinesterase inhibitor |
| Triazophos | acetyl cholinesterase inhibitor |
| Trichlorfon | acetyl cholinesterase inhibitor |
| Triflumuron | chitin synthesis inhibitor |
| Trimethacarb | acetyl cholinesterase inhibitor |
| Vamidothion | acetyl cholinesterase inhibitor |
| XMC (3,5,-Xylyl- | acetyl cholinesterase inhibitor |
| methylcarbamate) | |
| Xylylcarb | acetyl cholinesterase inhibitor |
| YI 5301/5302 | |
| zeta.-Cypermethrin | sodium channel modulator |
| Zetamethrin | sodium channel modulator |

Non limitative examples of suitable anthelminthics are named in the following, a few representatives have insecticidal and acaricidal activity in addition to the anthelminthic activity, and are partly already in the above list.
(A1) Praziquantel=2-cyclohexylcarbonyl-4-oxo-1,2,3,6,7,11b-hexahydr-o-4H-pyrazino[2,1 -.alpha.]isoquinoline
(A2) Closantel=3,5-diiodo-N-[5-chloro-2-methyl-4-(a-cyano-4-chlorob-enzyl)phenyl]-salicylamide
(A3) Triclabendazole=5-chloro-6-(2,3-dichlorophenoxy)-2-methylthio-1H-benzimidazole
(A4) Levamisol=L-(−)-2,3,5,6-tetrahydro-6-phenylimidazo[2,1b]thiazo-le
(A5) Mebendazole=(5 -benzoyl-1H-benzimidazol-2-yl)carbaminic acid methylester
(A6) Omphalotin=a macrocyclic fermentation product of the fungus Omphalotus olearius described In WO 97/20857
(A7) Abamectin=avermectin B1
(A8) Ivermectin=22,23-dihydroavermectin B1
(A9) Moxidectin=5-O-demethyl-28-deoxy-25-(1,3-dimethyl-1-butenyl)-6-,28-epoxy-23-(methoxyimino)-milbemycin B
(A10) Doramectin=25-cyclohexyl-5-O-demethyl-25-de(1-methylpropyl)-a-vermectin A1a
(A11) Milbemectin=mixture of milbemycin A3 and milbemycin A4
(A12) Milbemycinoxim=5-oxime of milbemectin

### Non-Limitative Examples of Suitable Repellents and Detachers are:

(R1) DEET (N,N-diethyl-m-toluamide)
(R2) KBR 3023 N-butyl-2-oxycarbonyl-(2-hydroxy)-piperidine
(R3) Cymiazole=N,-2,3-dihydro-3-methyl-1,3-thiazol-2-ylidene-2,4-xy-lidene

The aforementioned partners in the mixture are best known to specialists in this field. Most are described in various editions of the Pesticide Manual, The British Crop Protection Council, London, and others in the various editions of The Merck Index, Merck & Co., Inc., Rahway, N.J., USA or in patent literature. Therefore, the following listing is restricted to a few places where they may be found by way of example.
(I) 2-Methyl-2-(methylthio)propionaldehyde-O-methylcarbamoyloxime (Aldicarb), from The Pesticide Manual, 11.sup.th Ed. (1997), The British Crop Protection Council, London, page 26;
(II) S-(3,4-dihydro-4-oxobenzo[d]-[1,2,3]-triazin-3-ylmethyl)O,O-di-methyl-phosphorodithioate (Azinphos-methyl), from The Pesticide Manual, 11.sup.th ed. (1997), The British Crop Protection Council, London, page 67;
(III) Ethyl-N-[2,3-dihydro-2,2-dimethylbenzofuran-7-yloxycarbonyl-(-methyl)aminothio]-N-isopropyl-.beta.-alaninate (Benfuracarb), from The Pesticide Manual, 11.sup.th Ed. (1997), The British Crop Protection Council, London, page 96;
(IV) 2-Methylbiphenyl-3-ylmethyl-(Z)-(1RS)-cis-3-(2-chloro-3,3,3-tr-ifluoroprop-1-enyl)-2,2-dimethylcyclopropanecarboxylate (Bifenthrin), from The Pesticide Manual, 11.sup.th Ed. (1997), The British Crop Protection Council, London, page 118;
(V) 2-tert-butylimino-3-isopropyl-5-phenyl-1,3,5-thiadiazian-4-one (Buprofezin), from The Pesticide Manual, 11.sup.th Ed. (1997), The British Crop Protection Council, London, page 157;
(VI) 2,3-Dihydro-2,2-dimethylbenzofuran-7-yl-methylcarbamate (Carbofuran), from The Pesticide Manual, 11.sup.th Ed. (1997), The British Crop Protection Council, London, page 186;
(VII) 2,3-Dihydro-2,2-dimethylbenzofuran-7-yl-(dibutylaminothio)met-hylcarbamate (Carbosulfan), from The Pesticide Manual, 11.sup.th Ed. (1997), The British Crop Protection Council, London, page 188;
(VIII) S,S′-(2-dimethylaminotrimethylene)-bis(thiocarbamate) (Cartap), from The Pesticide Manual, 11.sup.th Ed. (1997), The British Crop Protection Council, London, page 193;
(IX) 1-[3,5-Dichloro-4-(3-chloro-5-trifluoromethyl-2-pyridyloxy)phe-nyl]-3-(2,6-difluorobenzoyl)-urea (Chlorfluazuron), from The Pesticide Manual, 11.sup.th Ed. (1997), The British Crop Protection Council, London, page 213;
(X) O,O-diethyl-O-3,5,6-trichloro-2-pyridyl-phosphorothioate (Chlorpyrifos), from The Pesticide Manual, 11.sup.th Ed. (1997), The British Crop Protection Council, London, page 235;
(XI) (RS)-.alpha.-cyano-4-fluoro-3-phenoxybenzyl-(1RS,3RS;1RS,3RS)-3-(2,2-dichlorovinyl)-2,2-di-methylcyclopropanecarboxylate (Cyfluthrin), from The Pesticide Manual, 11.sup.th Ed. (1997), The British Crop Protection Council, London, page 293;
(XII) Mixture of (S)-.alpha.-cyano-3-phenoxybenzyl-(Z)-(1R,3R)-3-(2--chloro-3,3,3-trifluoropropenyl)-2,2-dimethylcyclopropanecarboxylate and (R)-.alpha.-cyano-3-phenoxybenzyl-(Z)-(1R,3)-3-(2-chloro-3,3,3-trifluorop-ropenyl)-2,2-dimethylcyclopropanecarboxylate (Lambda-Cyhalothrin), from The Pesticide Manual, 11.sup.th Ed. (1997), The British Crop Protection Council, London, page 300;
(XIII) Racemate consisting of (S)-.alpha.-cyano-3-phenoxybenzyl-(2)--(1R,3R)-3-(2,2-dichlorovinyl)-2,2-dimethylcyclopropanecarboxylate and (R)-.alpha.-cyano-3-phenoxybenzyl-(1S,3S)-3-(2,2-dichlorovinyl)-2,2-dimet-hylcyclopropanecarboxylate (Alpha-cypermethrin), from The Pesticide Manual, 11.sup.th Ed. (1997), The British Crop Protection Council, London, page 308;
(XIV) a mixture of the stereoisomers of (S)-.alpha.-cyano-3-phenoxy-benzyl (1RS,3RS,1RS,3RS)-3-(2,2-dichlorovinyl)-2,2-dimethylcyclopropaneca-rboxylate (zeta-Cypermethrin), from The Pesticide Manual, 11.sup.th Ed. (1997), The British Crop Protection Council, London, page 314;
(XV) (S)-.alpha.-cyano-3-phenoxybenzyl-(1R,3R)-3-(2,2-dibromovinyl)--2,2-dimethylcyclopropanecarboxylate (Deltamethrin), from The Pesticide Manual, 11.sup.th Ed. (1997), The British Crop Protection Council, London, page 344;
(XVI) (4-chlorophenyl)-3-(2,6-difluorobenzoyl)urea (Diflubenzuron), from The Pesticide Manual, 11.sup.th Ed. (1997), The British Crop Protection Council, London, page 395;
(XVII) (1,4,5,6,7,7-Hexachloro-8,9,10-trinorborn-5-en-2,3-ylenebism-ethylene)-sulphite (Endosulfan), from The Pesticide Manual, 11.sup.th Ed. (1997), The British Crop Protection Council, London, page 459;
(XVIII) .alpha.-ethylthio-o-tolyl-methylcarbamate (Ethiofencarb), from The Pesticide Manual, 11.sup.th Ed. (1997), The British Crop Protection Council, London, page 479;
(XIX) O,O-dimethyl-O-4-nitro-m-tolyl-phosphorothioate (Fenitrothion), from The Pesticide Manual, 11.sup.th Ed. (1997), The British Crop Protection Council, London, page 514;
(XX) 2-sec-butylphenyl-methylcarbamate (Fenobucarb), from The Pesticide Manual, 11.sup.th Ed. (1997), The British Crop Protection Council, London, page 516;
(XXI) (RS)-.alpha.-cyano-3-phenoxybenzyl-(RS)-2-(4-chlorophenyl)-3-methylbutyrate (Fenvalerate), from The Pesticide Manual, 11.sup.th Ed. (1997), The British Crop Protection Council, London, page 539;
(XXII) S-[formyl(methyl)carbamoylmethyl]-O,O-dimethyl-phosphorodith-ioate (Formothion), from The Pesticide Manual, 11.sup.th Ed. (1997), The British Crop Protection Council, London, page 625;
(XXIII) 4-Methylthio-3,5-xylyl-methylcarbamate (Methiocarb), from The Pesticide Manual, 11.sup.th Ed. (1997), The British Crop Protection Council, London, page 813;
(XXIV) 7-Chlorobicyclo[3.2.0]hepta-2,6-dien-6-yl-dimethylphosphate (Heptenophos), from The Pesticide Manual, 11.sup.th Ed. (1997), The British Crop Protection Council, London, page 670;
(XXV) 1-(6-chloro-3-pyridylmethyl)-N-nitroimidazolidin-2-ylidenamin-e (Imidacloprid), from The Pesticide Manual, 11.sup.th Ed. (1997), The British Crop Protection Council, London, page 706;
(XXVI) 2-isopropylphenyl-methylcarbamate (Isoprocarb), from The Pesticide Manual, 11.sup.th Ed. (1997), The British Crop Protection Council, London, page 729;
(XXVII) O,S-dimethyl-phosphoramidothioate (Methamidophos), from The Pesticide Manual, 11.sup.th Ed. (1997), The British Crop Protection Council, London, page 808;
(XXVIII) S-Methyl-N-(methylcarbamoyloxy)thioacetimidate (Methomyl), from The Pesticide Manual, 11.sup.th Ed. (1997), The British Crop Protection Council, London, page 815;
(XXIX) Methyl-3-(dimethoxyphosphinoyloxy)but-2-enoate (Mevinphos), from The Pesticide Manual, 11.sup.th Ed. (1997), The British Crop Protection Council, London, page 844;
(XXX) O,O-diethyl-O-4-nitrophenyl-phosphorothioate (Parathion), from The Pesticide Manual, 11.sup.th Ed. (1997), The British Crop Protection Council, London, page 926;
(XXXI) O,O-dimethyl-O-4-nitrophenyl-phosphorothioate (Parathion-methyl), from The Pesticide Manual, 11.sup.th Ed. (1997), The British Crop Protection Council, London, page 928;
(XXXII) S-6-chloro-2,3-dihydro-2-oxo-1,3-benzoxazol-3-ylmethyl-O,O-diethyl-phosphordithioate (Phosalone), from The Pesticide Manual, 11.sup.th Ed. (1997), The British Crop Protection Council, London, page 963;
(XXXIII) 2-Dimethylamino-5,6-dimethylpyrimidin-4-yl-dimethylcarbama-te (Pirimicarb), from The Pesticide Manual, 11.sup.th Ed. (1997), The British Crop Protection Council, London, page 985;
(XXXIV) 2-isopropoxyphenyl-methylcarbamate (Propoxur), from The Pesticide Manual, 11.sup.th Ed. (1997), The British Crop Protection Council, London, page 1036;
(XXXV) 1-(3,5-dichloro-2,4-difluorophenyl)-3-(2,6-difluorobenzoyl)u-rea (Teflubenzuron), from The Pesticide Manual, 11.sup.th Ed. (1997), The British Crop Protection Council, London, page 1158;
(XXXVI) S-tert-butylthiomethyl-O,O-dimethyl-phosphorodithioate (Terbufos), from The Pesticide Manual, 11.sup.th Ed. (1997), The British Crop Protection Council, London, page 1165;
(XXXVII) ethyl-(3 -tert.-butyl-1-dimethylcarbamoyl-1H-1,2,4-triazol-5-yl-thio)-acetate, (Triazamate), from The Pesticide Manual, 11.sup.th Ed. (1997), The British Crop Protection Council, London, page 1224;
(XXXVIII) Abamectin, from The Pesticide Manual, 11.sup.th Ed. (1997), The British Crop Protection Council, London, page 3;
(XXXIX) 2-sec-butylphenyl-methylcarbamate (Fenobucarb), from The Pesticide Manual, 11.sup.th Ed. (1997), The British Crop Protection Council, London, page 516;
(XL) N-tert.-butyl-N′-(4-ethylbenzoyl)-3,5-dimethylbenzohydrazide (Tebufenozide), from The Pesticide Manual, 11.sup.th Ed. (1997), The British Crop Protection Council, London, page 1147;
(XLI) (.±.)-5-amino-1-(2,6-dichloro-.alpha.,.alpha.,.alpha.-triflu-oro-p-tolyl)-4-trifluoromethyl-sulphinylpyrazol-3-carbonitrile (Fipronil), from The Pesticide Manual, 11.sup.th Ed. (1997), The British Crop Protection Council, London, page 545;
(XLII) (RS)-.alpha.-cyano-4-fluoro-3-phenoxybenzyl(1RS,3RS;1 RS,3RS)-3-(2,2-dichlorovinyl)-2,2-dimethylcyclopropanecarboxylate (beta-Cyfluthrin), from The Pesticide Manual, 11.sup.th Ed. (1997), The British Crop Protection Council, London, page 295;
(XLIII) (4-ethoxyphenyl)-[3-(4-fluoro-3-phenoxyphenyl)propyl](dimet-hyl)silane (Silafluofen), from The Pesticide Manual, 11.sup.th Ed. (1997), The British Crop Protection Council, London, page 1105;
(XLIV) tert.-butyl (E)-.alpha.-(1,3-dimethyl-5-phenoxypyrazol-4-yl-methylenamino-oxy)-p-toluate (Fenpyroximate), from The Pesticide Manual, 11.sup.th Ed. (1997), The British Crop Protection Council, London, page 530;
(XLV) 2-tert.-butyl-5-(4-tert.-butylbenzylthio)-4-chloropyridazin-3-(2H)-one (Pyridaben), from The Pesticide Manual, 11.sup.th Ed. (1997), The British Crop Protection Council, London, page 1161;
(XLVI) 4-[[4-(1,1-dimethylphenyl)phenyl]ethoxy]-quinazoline (Fenazaquin), from The Pesticide Manual, 11.sup.th Ed. (1997), The British Crop Protection Council, London, page 507;
(XLVII) 4-phenoxyphenyl-(RS)-2-(pyridyloxy)propyl-ether (Pyriproxyfen), from The Pesticide Manual, 11.sup.th Ed. (1997), The British Crop Protection Council, London, page 1073;
(XLVIII) 5-chloro-N-{2-[4-(2-ethoxyethyl)-2,3-dimethylphenoxy]ethyl-}-6-ethylpyrimidine-4-amine (Pyrimidifen), from The Pesticide Manual, 11.sup.th Ed. (1997), The British Crop Protection Council, London, page 1070;
(XLIX) (E)-N-(6-chloro-3-pyridylmethyl)-N-ethyl-N′-methyl-2-nitrovi-nylidenediamine (Nitenpyram), from The Pesticide Manual, 11.sup.th Ed. (1997), The British Crop Protection Council, London, page 880;
(L) (E)-N.sup.1-[(6-chloro-3-pyridyl)methyl]-N.sup.2-cyano-N.sup.1-methylacetamidine (NI-25, Acetamiprid), from The Pesticide Manual, 11.sup.th Ed. (1997), The British Crop Protection Council, London, page 9;
(LI) Avermectin B.sub.1, from The Pesticide Manual, 11.sup.th Ed. (1997), The British Crop Protection Council, London, page 3;
(LII) an insect-active extract from a plant, especially (2R,6aS,12aS)-1,2,6,6a,12,12a-hexhydro-2-isopropenyl-8,9-dimethoxy-chrome-no[3,4-b]furo[2,3-h]chromen-6-one (Rotenone), from The Pesticide Manual, 11.sup.th Ed. (1997), The British Crop Protection Council, London, page 1097; and an extract from Azadirachta indica, especially azadirachtin, from The Pesticide Manual, 11.sup.th Ed. (1997), The British Crop Protection Council, London, page 59; and
(LII) a preparation which contains insect-active nematodes, preferably Heterorhabditis bactedophora and Heterorhabditis megidis, from The Pesticide Manual, 11.sup.th Ed. (1997), The British Crop Protection Council, London, page 671; Steinemema feltiae, from The Pesticide Manual, 11.sup.th Ed. (1997), The British Crop Protection Council, London, page 1115 and Steinemema scaptedsci, from The Pesticide Manual, 11.sup.th Ed. (1997), The British Crop Protection Council, London, page 1116;
(LIV) a preparation obtainable from Bacillus subtilis, from The Pesticide Manual, 11.sup.th Ed. (1997), The British Crop Protection Council, London, page 72; or from a strain of Bacillus thuringiensis with the exception of compounds isolated from GC91 or from NCTC11821; The Pesticide Manual, 11.sup.th Ed. (1997), The British Crop Protection Council, London, page 73;
(LV) a preparation which contains insect-active fungi, preferably Verticillium lecanii, from The Pesticide Manual, 11.sup.th Ed. (1997), The British Crop Protection Council, London, page 1266; Beauveda brogniartii, from The Pesticide Manual, 11.sup.th Ed. (1997), The British Crop Protection Council, London, page 85 and Beauveda bassiana, from The Pesticide Manual, 11.sup.th Ed. (1997), The British Crop Protection Council, London, page 83;
(LVI) a preparation which contains insect-active viruses, preferably Neodipridon Sertifer NPV, from The Pesticide Manual, 11.sup.th Ed. (1997), The British Crop Protection Council, London, page 1342; Mamestra brassicae NPV, from The Pesticide Manual, 11.sup.th Ed. (1997), The British Crop Protection Council, London, page 759 and Cydia pomonella granulosis virus, from The Pesticide Manual, 11.sup.th Ed. (1997), The British Crop Protection Council, London, page 291;
(CLXXXI) 7-chloro-2,3,4a,5-tetrahydro-2-[methoxycarbonyl(4-trifluor-omethoxyphenyl)-carbamoyl]indol[1,2e]oxazoline-4a-carboxylate (DPX-MP062, Indoxycarb), from The Pesticide Manual, 11.sup.th Ed. (1997), The British Crop Protection Council, London, page 453;
(CLXXXII) N′-tert.-butyl-N′-(3,5-dimethylbenzoyl)-3-methoxy-2-methy-lbenzohydrazide (RH-2485, Methoxyfenozide), from The Pesticide Manual, 11.sup.th Ed. (1997), The British Crop Protection Council, London, page 1094; and
(CLXXXIII) (N′-[4-methoxy-biphenyl-3-yl]-hydrazinecarboxylic acid isopropylester (D 2341), from Brighton Crop Protection Conference, 1996, 487-493;
(R2) Book of Abstracts, 212th ACS National Meeting Orlando, Fla., Aug. 25-29 (1996), AGRO-020. Publisher: American Chemical Society, Washington, D.C. CONEN: 63BFAF.

As a rule, the anthelminthic compositions according to the invention contain 0.1 to 99% by weight, especially 0.1 to 95% by weight of active ingredient of Formula 1 mixtures thereof, 99.9 to 1% by weight, especially 99.8 to 5% by weight of a solid or liquid admixture, including 0 to 25% by weight, especially 0.1 to 25% by weight of a surfactant.

In another embodiment of the process according to the invention, compounds of Formula 1 and the additional compounds noted hereinbefore may be applied in a distinct and separate manner over time. In this case, it is preferred to alternate the applications with an interval, for example of one month between two applications.

### BIOLOGICAL EXAMPLES OF THE INVENTION

### Test A

### Test Example 1

### Eggs and Larvae of C. felis—Egg to Adult Development Assay

A larval support media was prepared consisting of 1 g dried bovine blood, 1 g dog biscuit and 5 g of fine sand. Two grams of the larval support media were placed into a 30 mL container for treatment with the test compound and drying. The test compound (3-bromo-N-[4-chloro-2-methyl-6-(methylcarbamoyl)phenyl]-1-(3-chloropyridin-2-yl)-1H-pyrazole-5-carboxamide) was prepared in acetone and serially diluted prior to testing. The concentrations used were as follows: 1 ug/uL, 0.5, 0.25, 0.125, 0.0625 ug/uL. 30 eggs of C. felis were placed into the culturing medium. Each concentration was replicated 3 times giving a total of 90 eggs per dose level. The untreated control was treated with acetone only. The containers were placed into a temperature and humidity controlled room and maintained for 28 days. After the incubation period had elapsed the containers were placed into a freezer for 1 hour. The adults and pupae were counted and % of adults and pupae that developed at each dose level was calculated. The activity was compared to Methoprene.

Egg to adult development in Pilot assay
% eggs developed into adults

| | | Test |
|---|---|---|
| Concentration | Methoprene | Compound |
| 1.0 | 0.0 | 0.0 |
| 0.5 | 0.0 | 0.0 |
| 0.25 | 1.1 | 0.0 |
| 0.125 | 3.3 | 0.0 |
| 0.0625 | 14.4 | 18.9 |
| Control | 71.1 | 68.9 |

Although the present invention and its advantages have been described in detail, it should be understood that various changes, substitutions and alterations can be made herein without departing from the spirit and scope of the invention as defined by the appended claims.

What is claimed is:

1. A method of controlling or preventing maturation of fleas on a warm blooded animal or its environment comprising applying to a warm blooded animal or its environment a composition comprising a developmentally disruptive amount of a compound of Formula 1 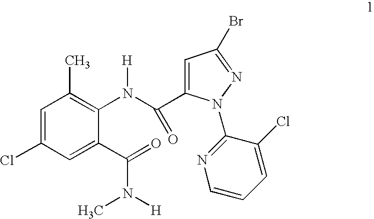
or an N-oxide, or a salt thereof.

2. The method of claim 1 wherein the warm blooded animal is either a dog or a cat.

3. The method of either of claims 1 or 2 wherein the compound of Formula 1 is contained within a composition which comprises at least one additional component selected from the group consisting of solvents and/or carriers, emulsifiers and/or dispersing agents.

4. The method of claim 3 wherein the composition comprises at least one additional biologically active compound or agent.

5. The method of claim 4 wherein the additional biologically active compound or agent is selected from the group consisting of macrocyclic lactones, acetyl cholinesterase inhibitors, arthropod growth regulators, GABA-gated chloride channel antagonists, mitochondrial electron transport inhibitors, nicotinic acetylcholine agonists/antagonists/activator, oxidative phosphorylation inhibitors, anthelminthics, sodium channel modulators or other antiparasitic compounds.

6. The method of claim 5 wherein said biologically active compound is a macrocyclic lactone.

7. The method of claim 5 wherein said biologically active compound is an acetyl cholinesterase inhibitor selected from the group of organophosphates and carbamates.

8. The method of claim 5 wherein said biologically active compound is an arthropod growth regulator selected from the group of chitin synthesis inhibitors, ecdysone agonists/disruptors, lipid biosynthesis inhibitor and juvenile hormone mimics.

9. The method of claim 5 wherein said biologically active compound is a GABA-gated chloride channel antagonist.

10. The method of claim 5 wherein said biologically active compound is a mitochondrial electron transport inhibitor.

11. The method of claim 5 wherein said biologically active compound is a nicotinic acetylcholine agonist/antagonist/activator.

12. The method of claim 5 wherein said biologically active compound is an oxidative phosphorylation inhibitor.

13. The method of claim 8 wherein said biologically active compound is an anthelminthic.

14. The method of claim 8 wherein said biologically active compound is a sodium channel modulator.
